(19) United States
(12) Patent Application Publication
(10) Pub. No.: US 2008/0093572 A1
(43) Pub. Date: Apr. 24, 2008

(54) Sensing water faucet structure

(76) Inventor: Pauli Wu, Taipei (TW)

Correspondence Address: PAULI WU, 20525 Via Talavera, Yorba Linda, CA, 92887, US

(21) Appl. No.: 11/592,410

(22) Filed: Oct. 19, 2006

(51) Int. Cl. F16K 31/02

(52) U.S. Cl. 251/129.04

(57) ABSTRACT

An improved sensing water faucet structure includes a support unit comprised of a base body, a fixing rod and an outlet pipe; a bushing sheathed onto the base body; a sensor installed on a sidewall in the bushing; and a fixing unit disposed at an end of the bushing an end. The fixing unit has an interconnecting portion with an end coupled to the outlet pipe and another end having an outlet faucet, so as to achieve the effects of manufacturing, assembling, using, maintaining, installing and removing the sensing water faucet.

### FIELD OF THE INVENTION

The present invention relates to an improved sensing water faucet structure, and more particularly to a sensing water faucet with the effects of manufacturing, assembling, using, maintaining, installing and removing the water faucet.

### BACKGROUND OF THE INVENTION

Referring to FIG. 1 for a traditional sensing water faucet 6, the faucet 6 comprises a base 61, a penetrating hole 71 disposed on the base 61 and corresponding to a sink 7, a casing pipe 62 installed correspondingly to the base 61, a fixing base 63 soldered at an appropriate position of the casing pipe 62, a fixing hole 631 disposed on the fixing base 63, a pillar 72 screwed into the fixing hole 631 and passed into the penetrating hole 71 of the sink 7, a spacer 721 installed at the bottom of penetrating hole 71, a screw insert 722 coupled onto the pillar 72 for fixing the pillar 72 into the penetrating hole 71 and passed through the base 61 and screwed with the fixing hole 631, an outlet pipe 73 installed at a corresponding side of the pillar 72, an interconnecting hole 632 disposed on a side of the fixing hole 631 and having an end connected to an outlet pipe 73, an outlet faucet 64 installed at another end of the interconnecting hole 632 and coupled to the outlet pipe, and a sensor 65 installed on a sidewall in the casing pipe 62; such that the sensor can be triggered by a sensing method to allow water to flow from the outlet faucet 64 to the outside through the outlet pipe 73.

Although the structure of the foregoing traditional sensing water faucet 6 can trigger a sensor 65 by a sensing method to allow water to flow out from the water faucet 6 for the use of water, a fixing base 63 is soldered to the interior of a casing pipe 62 in the structure, such that when the fixing base 63 is soldered, the soldering process will not be easy because the soldering is restricted by the overall structure and volume of the casing pipe 62, and it is necessary to solder the fixing base 63 precisely at a predetermined position in the casing pipe 62. If there is any error or askew solder, the outlet pipe 73 and the pillar 72 cannot be aligned with each other for the installation, and thus making the level of difficulty of the installation much higher. If it is necessary to maintain, install, remove or replace the sensing water faucet 6 for installation or damages, the maintenance people have to install or remove the screw insert 722, spacer 721 and pillar 72a from the bottom of the sink 7, and then install or remove the casing pipe 62 and outlet faucet 64 from the top of the sink 7. As to a general sink 7 which is usually installed at a position proximate to a wall, the wall and the pillar 72 are very near to each other. Thus, it is difficult for maintenance people to carry out the maintenance work when they perform an installation or removal at the bottom of the sink 7.

### SUMMARY OF THE INVENTION

Therefore, it is a primary objective of the present invention to provide a sensing water faucet that installs a support unit, a bushing and a fixing unit to achieve the effects of manufacturing, assembling, using, maintaining, installing and removing the sensing water faucet easily.

To achieve the foregoing objective, an improved sensing water faucet structure of the invention comprises: a support unit comprised of a base body, a fixing rod and a outlet pipe; a bushing sheathed onto the base body and having a sensor installed on a sidewall in the bushing; and a fixing unit installed at an end of the bushing and having an interconnecting portion with an end coupled to the outlet pipe and an outlet faucet disposed at another end of the interconnecting portion.

### BRIEF DESCRIPTION OF THE DRAWINGS

FIG. 1 is a schematic cross-sectional view of an assembled structure of a prior art;

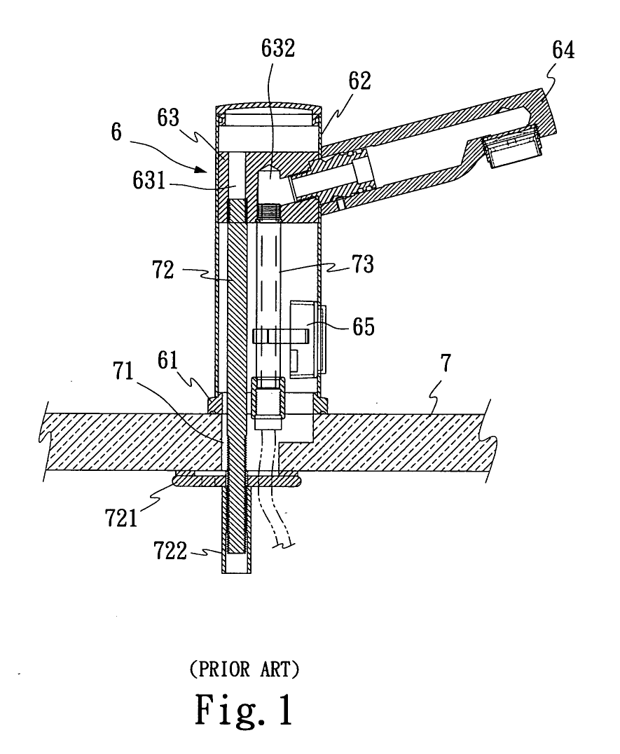

FIG. 2 is a schematic cross-sectional view of a disassembled structure in accordance with the invention; and

FIG. 3 is a schematic cross-sectional view of an assembled structure in accordance with the invention.

### DETAILED DESCRIPTION OF THE PREFERRED EMBODIMENTS

The above and other objects, features and advantages of the present invention will become apparent from the following detailed description taken with the accompanying drawing.

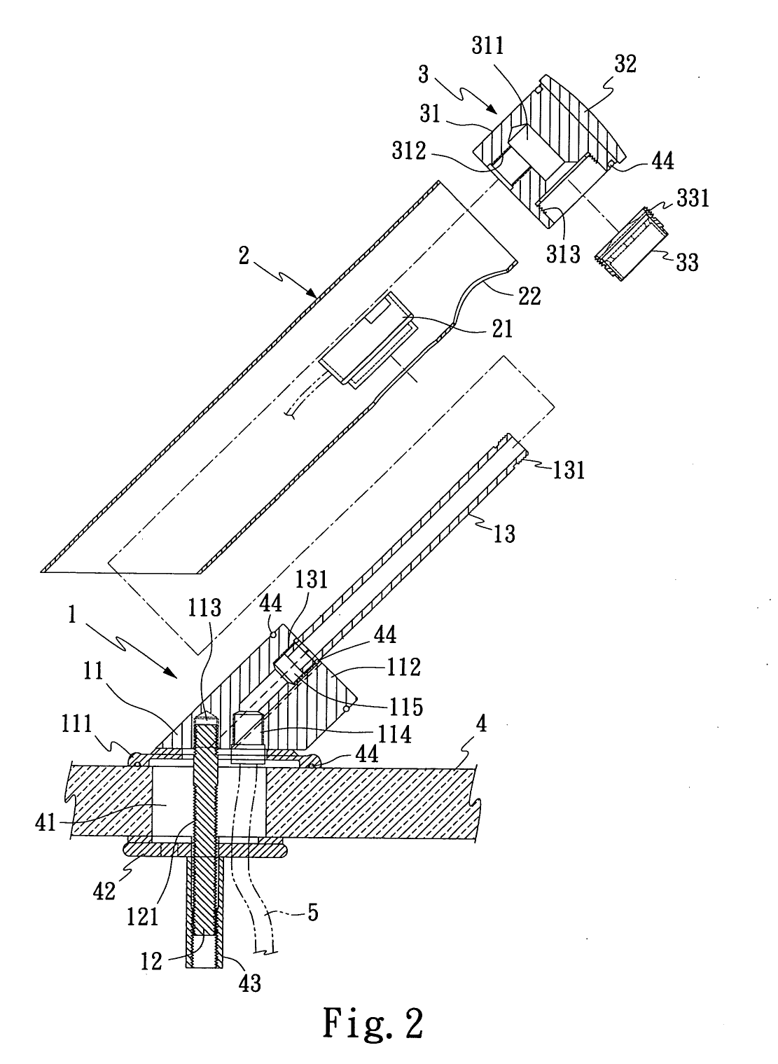

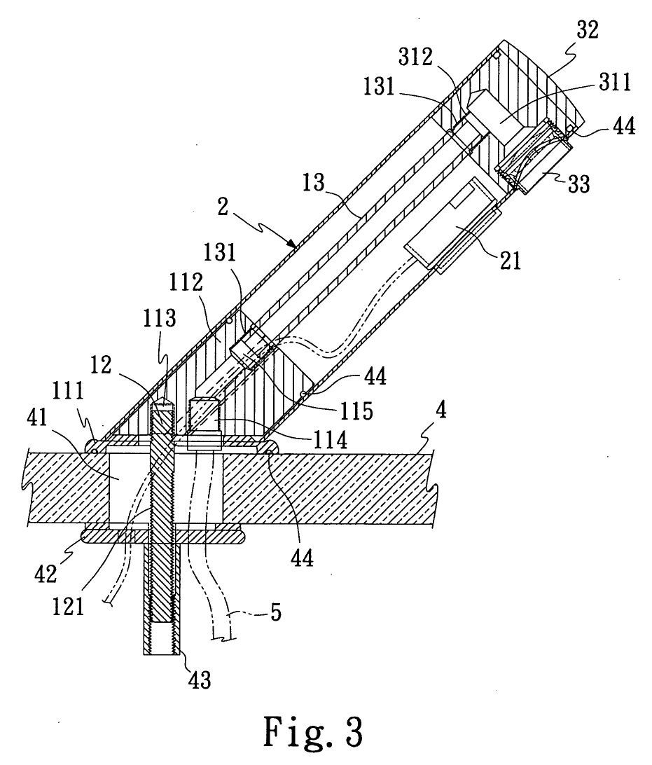

Referring to FIGS. 2 and 3 for schematic cross-sectional views of assembled and disassembled structures of the present invention respectively, an improved sensing water faucet structure of the invention comprises a support unit 1, a bushing 2 and a fixing unit 3 for achieving the effects of manufacturing assembling, using, maintaining, installing and removing a sensing water faucet.

The support unit 1 comprises a base body 11, a fixing rod 12 and an outlet pipe 13. The base body 11 has a base 111, a protruding pillar 112 extended obliquely upward from a distal surface of the base 111, and screw holes 113, 114, 115 disposed at the bottom and top of the protruding pillar 112 respectively for screwing to an external feed pipe 5 and an outlet pipe 13 installed around an external thread portion 131, and the fixing rod 12. The screw hole 113 at the bottom of the protruding pillar 112 is installed around a screw thread portion 121.

The bushing 2 is sheathed onto the protruding pillar 112 of the base body 11 disposed at the support unit 1, and an end of the bushing 2 is an oblique surface, and a sidewall in the bushing 2 has a sensor 21, and the circuit of the sensor 21 controls a valve (not shown in the figure) connected to an external feed pipe 5, and a penetrating hole 22 is disposed on a sidewall of the bushing 2 proximate to the sensor 21.

The fixing unit 3 has an interconnecting portion 311, an extended section 31 disposed on an end of the bushing, and a stopping portion 32 disposed on a distal surface of the extended section 31. Both ends of the interconnecting portion 311 of the fixing unit 3 have internal thread portions 312, 313 respectively, wherein the internal thread portion 312 at one end is screwed with the external thread portion 131 at an end of the outlet pipe 13 and the internal thread portion 313 at another end is screwed correspondingly to an outlet faucet 33 of an external thread portion 331, so as to constitute a novel improved sensing water faucet structure.

When the present invention is in use, the base 111 of the base body 11 and the protruding pillar 112 of the support unit 1 are installed at a corresponding connecting hole 41 of a sink 4, and the screw holes 113 at the bottom of the fixing rod 12 and protruding pillar 112 are screwed and passed through the connecting hole 41, and the screw hole 114 at the bottom of the protruding pillar 112 is coupled to the external feed pipe 5 that passes through the connecting hole 41, and the bottom of the connecting hole 41 has a spacer 42 for passing through the fixing rod 12 and the external feed pipe 5 and screwing with the exterior of the fixing rod 12 by a screw insert 43, and screwing the outlet pipe 13 disposed around an end of the external thread portion 131 with a screw hole 115 disposed at the top of the protruding pillar 112, such that the support unit 1 can be fixed onto the connecting hole 41 of the sink 4, and then an end with an oblique surface of the bushing 2 is disposed onto the protruding pillar 112 of the base body 11, and the extended section 31 of the fixing unit 3 is passed at another end of the bushing 2, and the internal thread portion 312 at an end of the interconnecting portion 311 is screwed with the external thread portion 131 at another end of the outlet pipe 13. After the connection of these portions 311, 131 reaches a predetermined depth, the stopping portion 32 at a distal surface of the extended section 31 is restricted. In the meantime, the internal thread portion 313 at another end of the interconnecting portion 311 corresponds to the penetrating hole 22 on a sidewall of the bushing 2, and finally the outlet faucet 33 uses its external thread portion 331 to screw with the internal thread portion 313 at another end of the interconnecting portion 311, and the base 111, protruding pillar 112 and extended section 31 are installed together with a water-resisting washer 44, so as to complete installing the sensing water faucet of the present invention.

If it is necessary to replace a damaged sensing water faucet, maintenance people can turn and remove the outlet faucet 33 and fixing unit 3, and detach the bushing 2 from the protruding pillar 112, so as to replace the desired components and achieve the necessary maintenance and replacement.

In summation of the description above, the improved sensing water faucet structure of the invention can effectively overcome the shortcomings of the prior art, such that the sensing water faucet can use the installation of the support unit, the bushing and the fixing unit to achieve the effects of manufacturing, assembling, using, maintaining, installing and removing the water faucet easily, and thus the invention complies with the patent application requirements and is duly filed for the patent application.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An improved sensing water faucet structure, comprising:
a support unit, having a base body, a fixing rod disposed at the bottom of said base body, and an outlet pipe installed on said base body;
a bushing, sheathed onto said base body of said support unit, and having a sensor installed on a sidewall in said bushing; and
a fixing unit, disposed at an end of said bushing, and having an interconnecting portion with an end coupled to the outlet pipe and another end coupled to an outlet faucet.

2. The improved sensing water faucet structure of claim 1, wherein said base body is comprised of a base and a protruding pillar extended upward from a distal surface of said base.

3. The improved sensing water faucet structure of claim 1, wherein said fixing rod has a screw thread portion disposed around said fixing rod, and said base body has a screw hole disposed at the bottom of said base body and screwed with said fixing rod.

4. The improved sensing water faucet structure of claim 1, wherein said outlet pipe has an external thread portion disposed around both ends of said outlet pipe respectively and said external thread portion has an end coupled to a screw hole disposed at the top of said base body and another end provided for connecting said interconnecting portion.

5. The improved sensing water faucet structure of claim 1, wherein said bushing has a penetrating hole disposed on a sidewall proximate to said sensor.

6. The improved sensing water faucet structure of claim 1, wherein said fixing unit has an interconnecting portion, an extended section disposed at an end of said bushing, and a stopping portion installed at a distal surface of said extended section.

7. The improved sensing water faucet structure of claim 1, wherein said fixing unit has an internal thread portion disposed at an end of said interconnecting portion and screwed with an end of said outlet pipe.

8. The improved sensing water faucet structure of claim 1, wherein said fixing unit has an internal thread portion disposed at another end of said interconnecting portion, and said outlet faucet has an external thread portion screwed with said internal thread portion.
